(19) United States
(12) Patent Application Publication
(10) Pub. No.: US 2012/0066059 A1
(43) Pub. Date: Mar. 15, 2012

(54) SYSTEM AND METHOD FOR PROVIDING VIDEO CLIPS, AND THE CREATION THEREOF

(75) Inventor: Richard Berger, Westlake Village, CA (US)

(73) Assignees: SONY PICTURES TECHNOLOGIES INC., Culver City, CA (US); SONY CORPORATION, Tokyo (JP)

(21) Appl. No.: 13/227,795

(22) Filed: Sep. 8, 2011

Related U.S. Application Data
(60) Provisional application No. 61/381,020, filed on Sep. 8, 2010.
(60) Provisional application No. 61/428,510, filed on Dec. 30, 2010.

(51) Int. Cl. G06Q 30/02; G06F 17/30

(52) U.S. Cl. 705/14.49; 707/769; 707/E17.014

(57) ABSTRACT

Systems and methods are provided for retrieving and presenting video clips. In one implementation, a computer system provides a clip engine implemented within a software application to retrieve video clips from a database. The clip engine receives requests for video clips in different modes and provides video data matching the requests. The modes may include, e.g., a daily mode, a search mode, a quiz mode, and a response form mode, and may include information to allow purchase of the video content, e.g., a movie or television program, associated with the clip. A desktop or digital widget, e.g., a calendar application, may be provided to deliver new video clips each day. The widget may also provide an option to buy the content item. The widget may run on a portable device, e.g., mobile phone, media player, computer, or another device, such as a game console or television.

### CROSS-REFERENCE TO RELATED APPLICATIONS

This application claims benefit of priority of U.S. Provisional Patent Application Ser. No. 61/381,020, filed Sep. 8, 2010, entitled “MOVIE CLIP OF THE DAY”, and U.S. Provisional Patent Application Ser. No. 61/428, 510, filed Dec. 30, 2010, entitled “CLIP ENGINE”, both of which are assigned to the owner of the current application and incorporated by reference herein in their entirety.

### FIELD OF THE INVENTION

The invention relates to creating, sharing, and displaying clips on digital devices, such as movie clips and trailers.

### BACKGROUND OF THE INVENTION

Digital delivery of content such as video content, e.g., movies and television shows, has created entirely new ways for such products to be marketed and distributed. In some cases, a flat fee provides users with access to a library of content, and content items within the library can be used or consumed as often as desired. In other systems, e.g., transactional systems, a user pays for each content item or group of content items, e.g., a season of the television show or an individual movie. In either case, content items may be streamed or downloaded to a user's system, which may be a computer, a tablet, a mobile device, or the like.

Marketing of such digital content continues to evolve as well. In many current cases, marketing is performed in the same way as its nondigital counterpart, just translated to the digital space. For example, a user may receive notification of a movie via an e-mail list, and the user then navigates to a content provider to purchase a DVD or download the desired content item. Such systems are thus static and do not provide additional advantages over prior marketing endeavors.

Regarding marketing endeavors, one way people remember and discuss movies is by thinking about their favorite parts. People often identify a movie by a famous scene or quote, and it is often an enjoyable pastime to discuss the same. Movie databases, accessible to such consumers, often even provide lists of such scenes and quotes. But while such scenes may be accessible on video filesharing sites, they are often not presented in a consistent or interesting way, or in a way that increases purchase of the corresponding content item. Even worse, such scenes often are pirated and thus do not provide appropriate compensation to their owners.

### SUMMARY OF THE INVENTION

Certain implementations of the present invention provide systems and methods for users to view and share clips such as movie clips, providing an entertaining way for people to enjoy movies. Such clips may be provided in a high quality and consistent fashion, thus increasing their enjoyment and increasing the chance a viewer will purchase a corresponding content item or items. Viewers may even select their own clips and create their own playlist of selected clips. Presentation of such clips may be via a number of “mode applications”, including being provided on a daily or other periodic basis using a calendar application, by direct searching, by interaction with a quiz, by interaction with a social networking site, by interaction with a response form, e.g., to answer questions about user characteristics and to thereby provide clips corresponding to such characteristics. Other ways such clips may be presented will also be understood given this disclosure.

In one implementation, a computer system provides a clip engine to send video clips to requesting clients, e.g., systems, users, or processes. The clip engine interacts with a database storing video clips, e.g., storing video data in MPEG files, to retrieve clips matching the client requests. The user can view the returned clip, share the clip with others, directly or by link, and purchase (or rent) the corresponding video content, e.g., the movie from which the clip was taken. The clip may be provided to the user for free or for a fee. The clip can be provided and accessed on various devices, such as a PC, game console, portable gaming device, mobile phone, media player, tablet or laptop computer, or the like. The clip may also be provided on-the-fly by receiving or determining an in-point and out-point that uniquely determine the clip. By knowledge of the in-point and out-point, the clip may be “grabbed” or “cut” from a full-length version of the content item, e.g., the movie.

The clip engine can operate in many modes. In each mode, the types of available requests may be different and may determine how the clip engine selects a clip or clips to return. In one implementation, each mode has a different interface for the user operating as a separate application. The user interacts with the mode application and the mode application interacts with the clip engine, sharing data as appropriate. The modes can also be implemented to operate together or with overlapping functionality. In one implementation, the clip engine has the following modes: search, quiz, personality, and daily.

In the search mode, the clip engine uses specific criteria to locate a particular clip or a group of clips, such as movie title, dialog or quotes, actor, crew, year, language, country, studio, genre, box office sales, release dates, popularity, and so on. For example, a user could request available clips for a particular movie or actor. In another example, a user requests a clip corresponding to a particular quote. In another example, the clip engine derives one or more criteria and creates the query itself.

In a quiz mode, the clip engine provides clips to supplement questions in a quiz game. In one implementation, the clip is provided as part of a question, e.g., “identify the movie for this clip”, “identify the actor in this clip”, or “identify which clip is from a particular movie” (showing multiple clips). In another implementation, the clip is provided as the answer or part of the answer, e.g., when the answer to a question is a movie or a scene from a movie, the clip is provided to illustrate the movie or scene.

In “personality” mode, generally termed here a “response form”, the clip engine provides clips matching personality or mood traits. The traits are derived from a user profile and/or from answers to questions. The clip engine matches the identified traits to trait metadata associated with the clips, where the trait metadata may be assigned or derived. The returned clip provides an entertaining way for the user to express himself or herself by sharing the clip with friends or the public. In a variation, the traits are not for the requesting user but for another person, e.g., the intended recipient of the clip. The clip could also serve as a recommendation or suggestion of content that may match the user's or recipient's mood or personality. For example, if the clip matches (or is complementary to) the mood, the movie itself may be as well.

The clip engine receives various requests through mode applications, or directly, depending on the implementation. In one implementation, the clip engine provides the criteria of a request to the clip database and the clip database resolves which clip or clips to return. In another implementation, the clip engine results the target clips from client requests and requests specific clips from the clip database. In another implementation, the clip engine and clip database are integrated, e.g., the clip engine operates as the front end or interface to the clip database.

The clip engine may attach purchasing information to each clip, e.g., a URL to be displayed as a link or “buy now” button. The recipient of the clip can access a service to buy or rent the indicated content, e.g., content item(s) related to the clip, using that purchasing information, e.g., by clicking the link. The purchasing information is provided to the clip engine from appropriate providers, e.g., service providers that can sell or rent the content. In another implementation, the purchasing information is embedded in the video clip and stored with the clip in the clip database. In this case, the purchasing information could be transparent to the clip engine.

In one implementation, the clip engine operates in conjunction with a social networking site, such as Facebook®. Each of the mode applications may then be provided as an application or option within the site. Users of the site can access the applications at the site and the clip engine may in turn provide clips back to the site. Users can then view and share clips through the site, e.g., posting clips to their own pages or their friends' pages, or retrieving clips from other people's pages. For example, a user could search for their favorite movie quotes and post the resulting clips to their page or send the same to friends. In quiz mode, a user can take quizzes and challenges on the social networking site based on their favorite movies using clips in the questions and answers, provided by the clip engine. A user may respond to a form to find out what movie matches their personality, mood, or relationship. The clip engine can provide clips to post and share. In one implementation, the user can tag a clip for how it can be shared or reposted, e.g., not at all, one time, freely, or the like.

In the daily mode, the clip engine provides a new clip each day to the client. The clips can be selected at random, using weightings, or using specific rules. For example, the selection can be weighted based on a user profile and historical actions, e.g., purchases, click-thrus, viewings, or the user's library. Profile or historical information can also be provided to the clip engine from other sources. For example, in a social networking site, the interests of the user or a user's friends may also be used, e.g., the groups or interests to which the user is a fan may be employed as criteria. In another example, clips may be selected based on release dates, such as selecting a clip for movie on the day the movie is released on DVD or Blu-ray® disc.

In one implementation of the daily mode, when a user accesses a calendar application or service, the user is presented with a movie clip or trailer. A different clip may be presented each day, or on some other periodic basis. A different pool of clips may be available each day and a new clip may be selected each time the application is accessed. In another implementation, clips from the same movie may be shown on successive accesses, e.g., on the same day or over succeeding days. The clips may be stored on the device where the application resides, or can be downloaded or streamed as needed. Multiple clips can be played, either automatically or on request. Similarly, a user can replay a clip or request a specific clip. The movie clip can be displayed embedded in the calendar application, as an overlay, or separately. The movie clip can be presented by the calendar application or can be handled by a separate application invoked by the calendar application. The user can access additional information about the movie and also buy or rent the movie. The calendar application can coordinate with a content application or content service provider to manage a transaction to open access to the content, download or stream the content data, handle the financial transaction and manage digital rights, and the like. The user can forward the clip or a link to the same to another user. The user can also be presented with information about release dates pertinent to the movie or media, e.g., Blu-ray® disc or DVD release dates, or promotions, e.g., a link to a downloadable or printable coupon for purchase. Separate advertising can be added to the movie clip, such as overlaid or between clips.

In a related implementation, a mode application administrator may provide that specific titles and clips are scheduled on certain days. In this way, clips may be selected to be played in advance of their actual availability, or for other reasons.

In one aspect, the invention is directed towards a method of providing clips from a clip database to a client device using a clip engine, including: receiving a request for a clip from a client device; retrieving a clip responsive to the request from the clip database; and delivering the clip to the client device.

Implementations of the invention may include one or more of the following. The receiving a request for a clip from a client device may include receiving notification that a user has opened an application. The application may be a calendar application or a desktop widget or a social networking site application. The clip engine may be integrated into the clip database. The delivering may include streaming or downloading. The clip may include embedded data about purchasing a content item related to the clip. The method may further include downloading data about purchasing a content item related to the clip. The method may further include causing an offer to be displayed at the client device, the offer for a content item or for information, promotional materials, or goods or services related to the content item, the content item corresponding to the clip. The receiving a request for a clip from a client device may include receiving criteria indicative of one or more clips. The criteria may be from a user form. The user form may request information about user preferences, desires, indications, or moods. The criteria may be from a quiz, and the quiz question or answer may include a clip. The clip delivered to the client device may be a custom clip prepared by a user, using a method including: in a video file of a content item or in a premade sub clip, selecting an in-point and an out-point, and defining a custom sub clip between the in-point and the out-point; selecting a premade sub clip from a collection of premade sub clips; and stringing at least one defined custom sub clip and one selected premade sub clip in a desired order to create a custom clip. The method may further include adding titles, credits, music, scores, soundtrack, or sound or video effects to the custom clip. The method may further include sharing the custom clip by publishing the custom clip to a social networking site. The retrieving a clip may include delivering information about a content item and an in-point and an out-point of the content item to a clip database.

In another aspect, the invention is directed towards a clip engine for providing clips from a clip database to a client device, including: a communications module for a client device, the client communications module receiving client requests for clips from the client device and delivering retrieved clips to the client device; and a communications module for a clip database, the database communications module transmitting clip engine requests for clips from the clip engine to the clip database, and receiving clips from the clip database for subsequent transmission to a client device.

Implementations of the invention may include one or more of the following. The clip engine may form a front end of a clip database. At least one of the client requests or the clip engine requests may presented to the clip engine or the clip database, respectively, in the form of criteria, and the clip engine or the clip database, respectively, may resolve which clips to deliver on the basis of the criteria, which may be from a user form or quiz. The criteria may also be from at least one of user preferences, user settings, user data, or user ratings. The database communications module may transmit clip engine requests for clips by delivering information about a content item and an in-point and an out-point of the content item to the clip database.

In another aspect, the invention is directed towards a method for requesting and receiving clips from a clip database using a clip engine, including: generating a request for a clip in an application; transmitting the generated request to a clip engine; receiving a clip responsive to the request from a clip database or from the clip engine; and playing back the clip.

Implementations of the invention may include one or more of the following. The playing back may occur in the application. The playing back may occur overlaid on a user interface of a client device or in a plug-in. The method may further include displaying an offer, the offer for a content item or for information, promotional materials, or goods or services related to the content item, the content item corresponding to the clip.

In another aspect, the invention is directed towards a method of providing clips from a clip database to a client device using a clip engine, including: downloading a clip to a client device; receiving a request for a clip from a client device; and upon the receiving, causing a playback of the downloaded clip on the client device.

Implementations of the invention may include one or more of the following. The downloading may be performed as a background process, based on a user profile. The user profile may include information about at least one of user transaction or purchase history, user data from a social networking site, or user preferences.

In another aspect, the invention is directed towards a non-transitory computer readable medium, including instructions for causing a computing device to implement any of the above methods. Such media may include instructions that are downloaded as an application program to a client device.

In another aspect, the invention is directed towards a clip engine for providing clips from a clip database to a client device, including: a communications module for a client device, the client communications module receiving client requests for clips from the client device and delivering retrieved clips to the client device; and a communications module for a clip database, the database communications module transmitting clip engine requests for clips from the clip engine to the clip database, and arranging for transmission of clips from the clip database to a client device.

Advantages of the invention may include one or more of the following. Video clips may be provided on a daily or other periodic basis to client devices, providing users with memorable and enjoyable viewing experiences. Video clips may be provided based on search criteria, such as dialogue or quotes. Video clips may be provided to client devices based on a question for the user to answer, such as movie trivia questions, providing users with game opportunities and a way to test their knowledge of movies. Video clips may be provided to client devices based on user profiles and/or user responses to questions about current status, e.g. mood, providing users with a new way to express feelings and moods, or other sentiments. Information may be provided with video clips to allow users to purchase or rent corresponding content, e.g., a movie or music video, providing clients with a new way to access content and conversely allowing content providers new ways to reach users. Users can be reminded or informed of favorite movies, or informed of movies that a content provider wishes to market.

Other advantages will be apparent from the description which follows, including the figures and claims.

### BRIEF DESCRIPTION OF THE DRAWINGS

FIG. 1 is a schematic diagram of the system for providing and displaying video clips, according to the principles disclosed here.

FIG. 2 is a flowchart of a specific implementation of a method according to the principles disclosed here.

FIG. 3 is a flowchart implementing a general method according to the principles disclosed here.

FIG. 4 is an illustration demonstrating various exemplary ways in which a step within FIG. 3 may be performed, according to the principles disclosed here.

FIG. 5 illustrates various exemplary ways in which a step within FIG. 3 may be performed, according to the principles disclosed here.

FIG. 6 illustrates various exemplary ways in which a step within FIG. 3 may be performed, according to the principles disclosed here.

FIG. 7 illustrates various exemplary ways in which a clip engine may interact with a clip database, according to the principles disclosed here.

FIG. 8 illustrates another exemplary implementation of a clip engine and clip database, according to the principles disclosed here.

FIG. 9 illustrates an exemplary mode applications, or ways in which users may cause video clips to be displayed and played back, according to the principles disclosed here.

FIG. 10 illustrates one exemplary mode application, a quiz application, and exemplary steps that may be performed within the application, according to the principles disclosed here.

FIG. 11 illustrates exemplary steps that may be performed by a user to create a custom clip, the creation of a custom clip being another application according to the principles disclosed here.

FIG. 12 illustrates an exemplary implementation of a clip database according to the principles disclosed here.

FIG. 13 illustrates an exemplary implementation of a clip engine according to the principles disclosed here.

FIG. 14 illustrates an exemplary implementation of a client device according to the principles disclosed here.

FIG. 15 illustrates an exemplary implementation of a computing device showing various architectural components, the computing device being an exemplary representation of a device that may serve as the disclosed clip database, clip engine, or client device.

### DETAILED DESCRIPTION

Initially it is noted that the majority of the description below will relate to video clips, e.g., from movies. However, it will be understood that the term “clip” may relate to other sorts of digital content as well, e.g., audio clips, electronic books, music videos, television shows, and indeed practically any digital content item, and thus the scope of the invention is not limited to just video clips. In this specification, the term “clip” will refer to a small suggestive portion of a corresponding or related content item, in many cases serving to entice a user to purchase corresponding or related items. Multiple clips may pertain to a given content item, and vice versa. However, it will be understood that clips may be of any size, and may have arbitrary content.

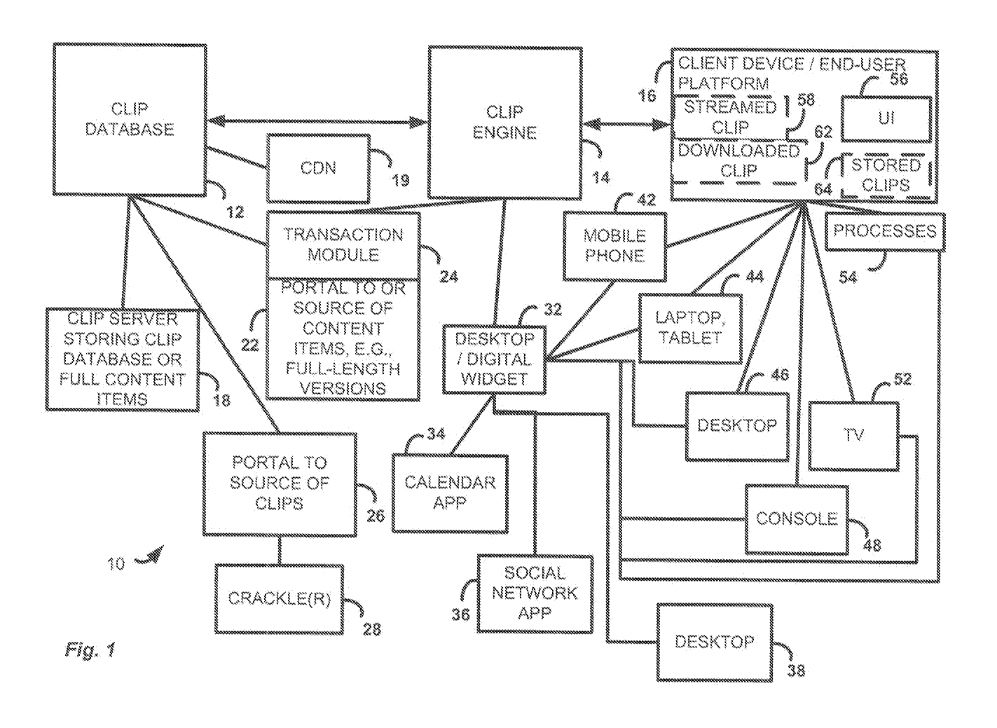

Referring to FIG. 1, a system 10 is shown in a logical diagram with various alternatives for the major components pictured. In particular, a clip database 12 is illustrated with a clip engine 14. An end user platform or client device 16 is illustrated as communicating with the clip engine 14. The client device 16 makes requests to the clip engine 14 for clips such as video clips, and the clip engine 14, with or without assistance from the clip database 12, resolves the requests and provides desired or determined clips to the client device 16. In some implementations, the clip engine arranges the providing but the clip database provides the clips directly to the client device.

The clip database 12 may be any type of server or other database system 18 that can store and provide clips upon request. Alternatively, instead of storing clips, the clip database 12 can create clips from full-length content items stored within the database 18. For example, the clip database 12 may receive a request from the clip engine 14, where the request includes an “in-point” and an “out-point” of a content item that together uniquely determine a video clip. In this way, such “virtual clips” may be created “on-the-fly”. It is also noted that the clip database 12 may be a “content delivery network” (CDN) 19 that, cumulatively within its nodes, can provide a content item from which the clip engine 14 can create a desired clip. In another implementation, the clip database 12 may be represented by a portal 26 to a third-party source of clips. Such a third-party source of clips may include video file viewing and sharing sites 28 such as Crackle®.

In one implementation, the clip database 12 may store content items and/or clips thereof, with currently existing metadata applied. The metadata may then be used in combination with a search query to identify one or more clips. Alternatively, the clip database 12 may be provided as a server specifically intended for the purpose of providing clips. For each content item within, appropriate rights may be arranged for and compensation made to the content item owner. Metadata may be provided for each scene or even for each frame. In other words, frame level metadata may be provided that includes such aspects as dialogue, actors, mood, what type of action is occurring, e.g., explosions, or the like. Certain scenes may be unavailable for business reasons, e.g., those not cleared for digital rights, those containing nudity, etc.

As is described in greater detail below, upon viewing a video clip, a user may be given the option to purchase or rent a corresponding or related content item. A purchase or rent transaction may be accomplished using a transaction module 24, which may lead to a portal or source 22 of full-length and/or related content items. The client device 16 may be directed to the transaction module 24 through the clip engine 14 as shown.

The client device 16 may interact with the clip engine 14 through a desktop or digital widget 32 which is implementable on a number of different types of devices. For example, the desktop widget 32 may be implemented on a mobile phone 42, a laptop or tablet computer 44, a desktop computer 46, a console system 48, a television 52, or generally within another software process 54. Other devices will also be understood, such as handheld game consoles and the like. The digital widget 32 may be implemented as a calendar application 34, a social network application 36, a desktop application 38, an option within a social network application, or in other forms. The clip may also be incorporated into a feed that may be imported into calendars or applications hosted elsewhere, e.g., in browser-based applications. Certain other forms will be described below as mode applications, and other applications will also be understood to be possible by one of ordinary skill in the art given this disclosure.

Clips may be returned from requests in a number of ways. Generally, a clip, or a group of clips, are found by matching criteria provided by a user or application against keywords or other meta-data within the clip. Clips may be provided for free or on a fee basis. For example, fees may be charged for enhanced clips or for clips that are provided along with a coupon for related content. Clips may also be personalized to the user, e.g., if the user is a fan of action-adventure movies, the video clips that are provided may focus on that genre. A user interface 56 for the clip may include a portion or a window allowing selection of clips, as well as for display of the clips and/or full-length content items related thereto. The user interface may also provide for promotions, marketing, and advertising of goods and services related to the clip. In an alternative implementation, the promotions, marketing, and advertising may form clips themselves, and such clips may overlay or be inserted within the retrieved video clips. The promotions, marketing, and advertising may be generated by a separate advertising server which interfaces with the clip engine 14 or clip database 12 to provide the advertising along with the clips, or may be embedded within the retrieved video clips themselves. The user interface for the video clips may also provide for a preview of upcoming video clips, as well as a way for a user to revisit past provided video clips. The user interface may further allow the user to replay played back clips.

The video clips may be streamed (shown as stream clip 58), or may be embodied as a downloaded clip 62. Alternatively, clips 64 may be previously stored on the client device 16, e.g., by being downloaded in a background process. In this way, when a clip is desired to be played back, the entire clip is available, even potentially in the absence of a network connection. In this implementation, a signal from the clip engine may be employed to instigate or initiate the playback of the stored clip.

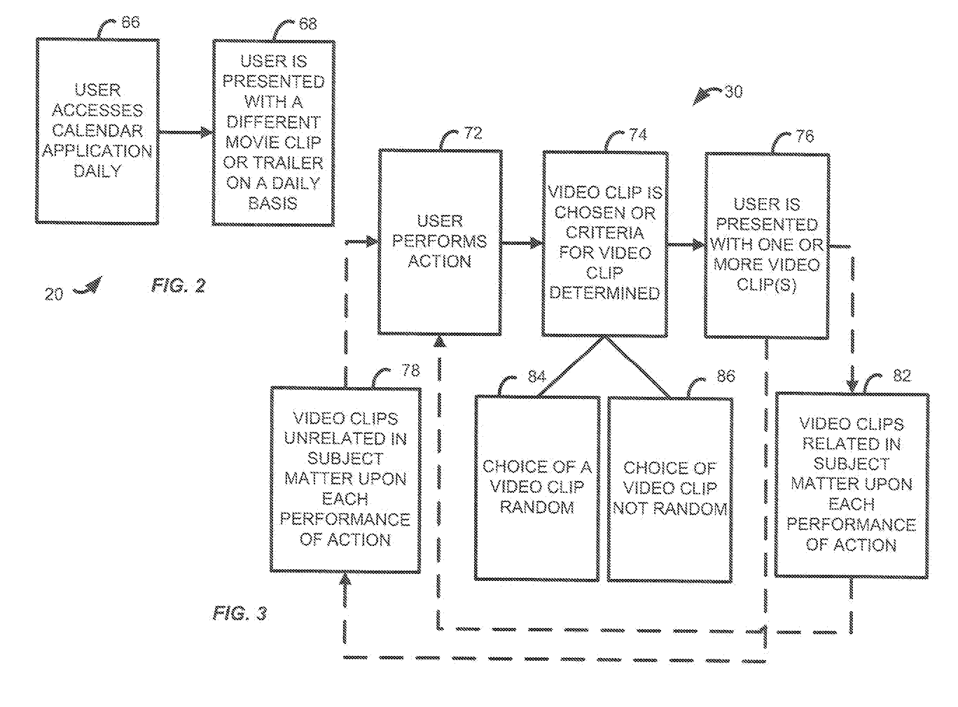

FIG. 2 is a flowchart 20 of a specific implementation of the invention. In the flowchart 20, a first step is that a user accesses a calendar application on a daily basis (step 66). For example, a user may open their calendar application in the morning as they begin work. It will be understood that a wide variety of alternatives exist, e.g., a user may keep their calendar open, and the clip engine may provide a clip at the same time each day, or on any other periodic basis set by the user, e.g., in an options or settings menu. A next step is that the user is presented with a different movie clip on a daily basis (or other periodic basis) (step 68). The clip may be a trailer or any other type of clip. The clip, termed in this implementation a “clip of the day”, may correspond to a day of the week. For example, as new DVDs are released on Tuesdays, the clip of the day for Tuesdays may correspond to newly released movies. Fridays may correspond to horror films, Saturdays to comedy, or any other basis set by the user or by a clip engine provider. Holidays may have their own sets of sources of clips. For example, on Halloween, horror clips may be provided. On Valentine's Day, clips from romantic films may be provided. Clips may be provided based on news of the day. For example, on Election Day, clips from political films may be provided. Clips may vary based on the time of day when they are played back. For example, if a clip is played back late at night, local time, a weighting may be provided such that a quieter clip is played back compared to a clip played back during the day.

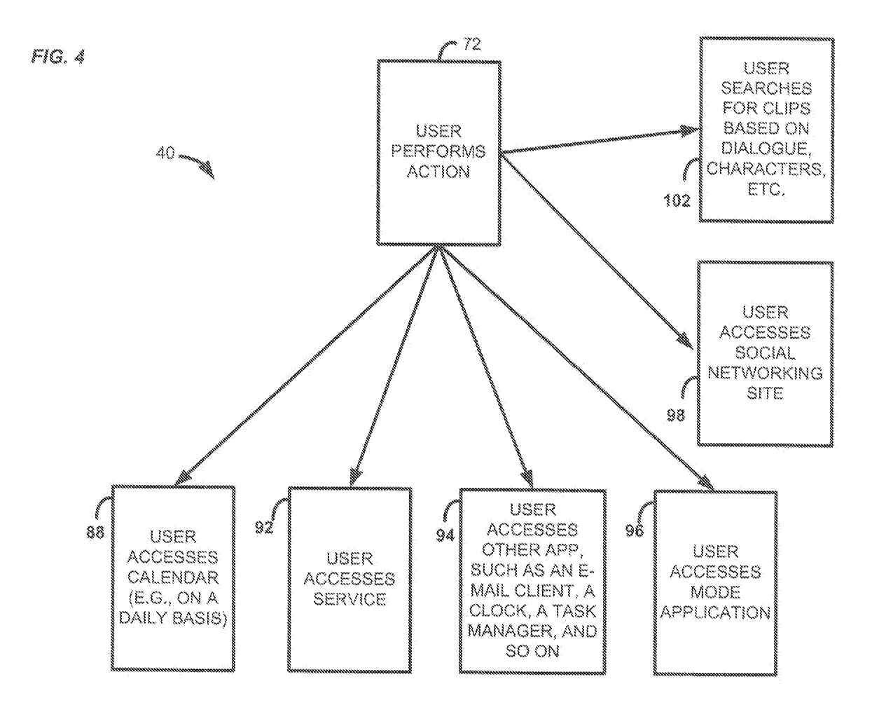

FIG. 3 is a flowchart 30 illustrating a general method according to an implementation of the principles disclosed here. In the flowchart 30, a first step is that a user performs an action (step 72). Specific types of actions are described below in connection with FIG. 4. Because of the action, a video clip is chosen or criteria for a video clip are determined (step 74).

The choice of video clip may, in this implementation, be in one of two ways. First, the choice of video clip may be random (step 84). In this implementation, a random video clip is provided to the user each day or on any other chosen periodic basis as described.

In another implementation, the choice of video clip is not random (step 86), but rather is determined on the basis of non-random criteria.

Where the choice of video clip is not random, in one case, a video clip may simply be selected by the user. Alternatively, where a user's action specifies criteria, the criteria may be used (or proxy criteria developed that are better suited) for matching against keywords or metadata in the clip database. Depending on how many clips are selected by the user, or how many clips meet the criteria, one or more clips may be returned to the user.

A next step in the flowchart 30 is that the user is presented with the one or more video clips (step 76). If a video clip has been uniquely determined by the user or by the criteria, the video clip may be presented and played back immediately. Alternatively, if several or many video clips meet the criteria, the user may be presented with a list of clips for their selection. The user may also be presented with the option to playback all of the clips.

Upon successive performances of the action, additional video clips may be provided and played back. In one implementation, the video clips may be related in subject matter (step 82). For example, scenes from the same movie, or movies from the same actor, genre, or director, or the like, may be presented upon successive performances of the action, e.g., as a user opens or accesses their calendar application, e.g., on the same day or over succeeding days. In another implementation, the video clips may be unrelated in subject matter (step 78).

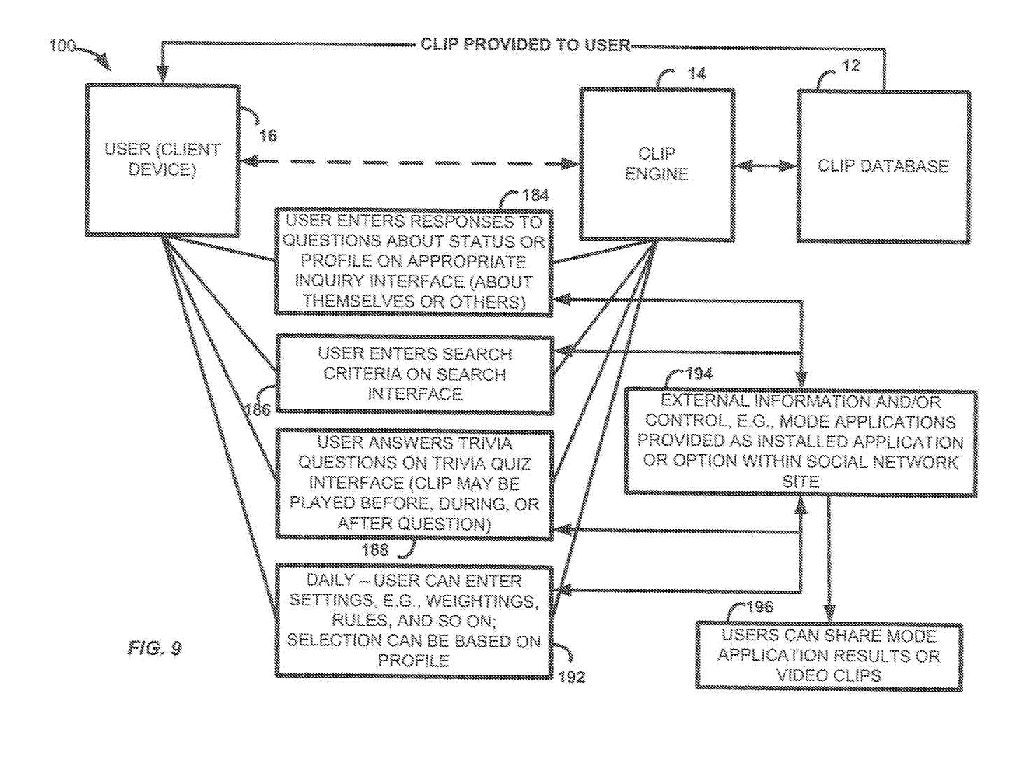

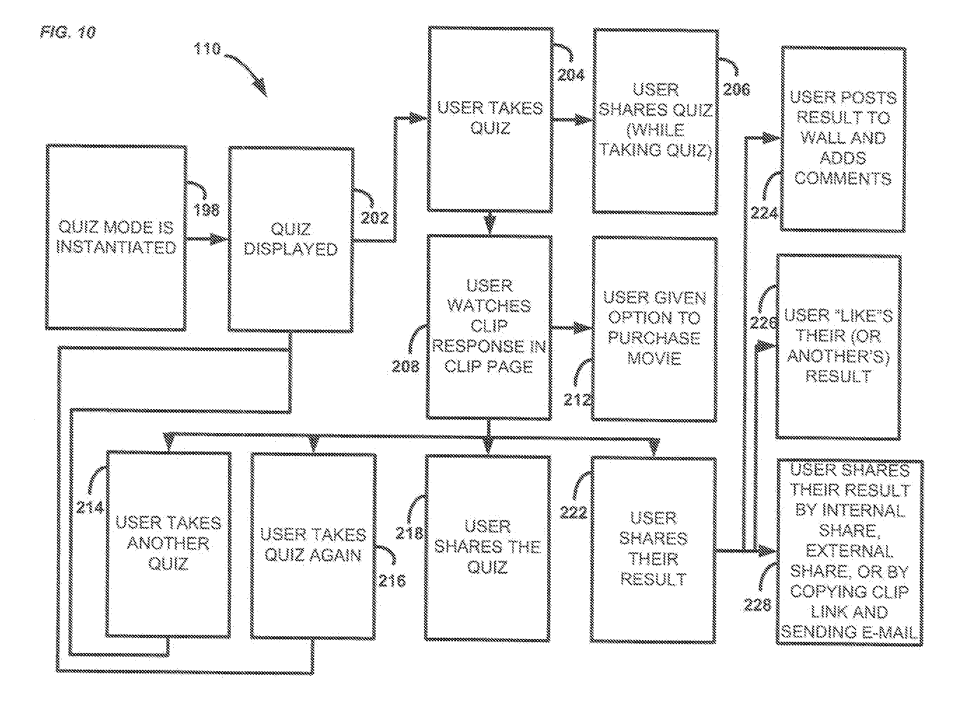

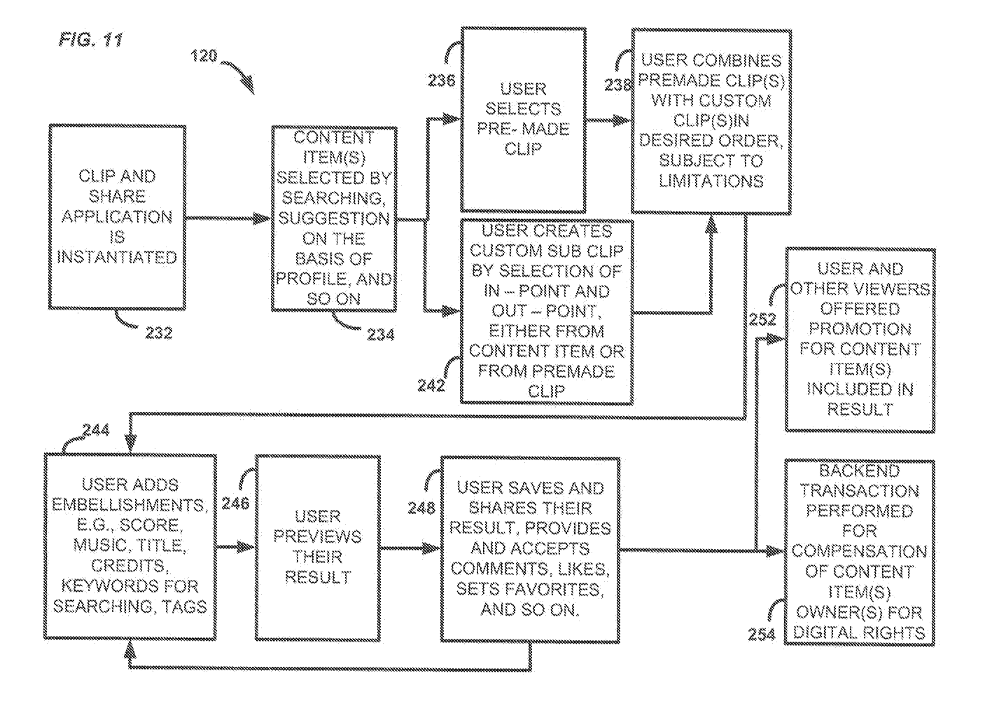

Referring to FIG. 4, a diagram 40 is shown illustrating different exemplary ways in which step 72, i.e., the user performing an action, may be accomplished. As noted above in reference to FIG. 2, one type of action a user may perform is to access their calendar, e.g., on a daily or other periodic basis (step 88). Another type of action is that a user may access a service (step 92). For example, a user may access a filesharing site, a commercial site for DVD rentals, a service for content item distribution or ticket sales, or the like. Besides accessing a calendar application, a user may also access another application (step 94), such as an e-mail client, a clock, a task manager, and so on. A user may also access one or more mode applications (step 96), as described in greater detail below in connection with FIGS. 9-10.

A user may access a social networking site (step 98), and the same may provide a social networking application or option within the site that may receive a feed from a clip engine and allow a user to access or share video clips thereon. As will be described, the mode applications may also be implemented within the context of the social networking site. In another way that a user may perform an action, a user may directly search for clips (step 102) based on dialogue, characters, and so on. A number of clips may be returned, and a user may select from among them for viewing and/or sharing. It will be understood that the above actions are merely exemplary, and a user may perform any number of actions within the context of the principles described here.

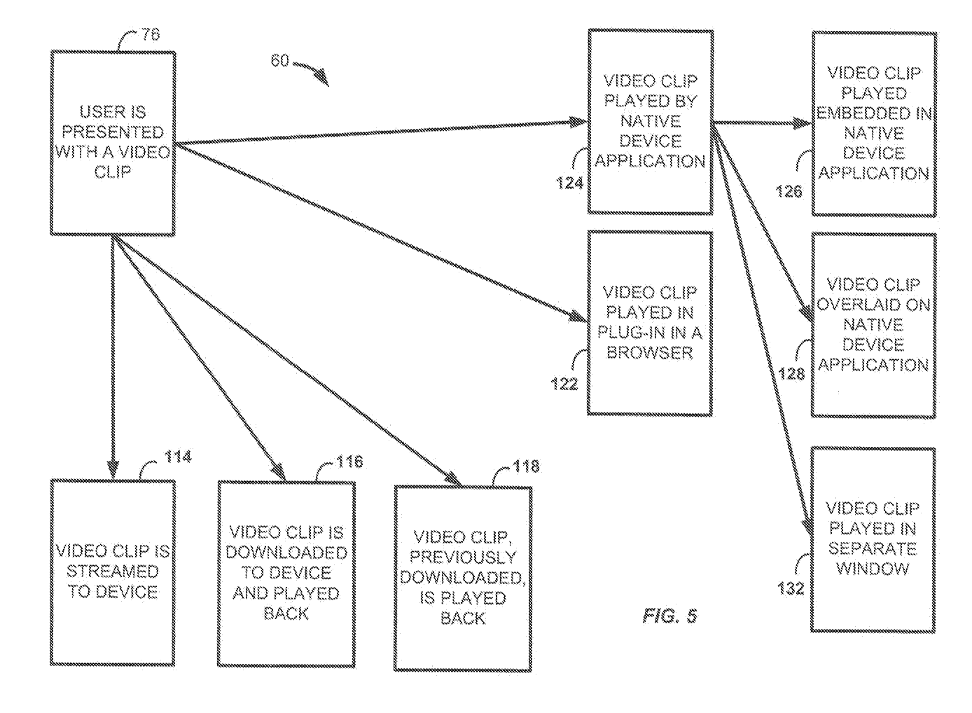

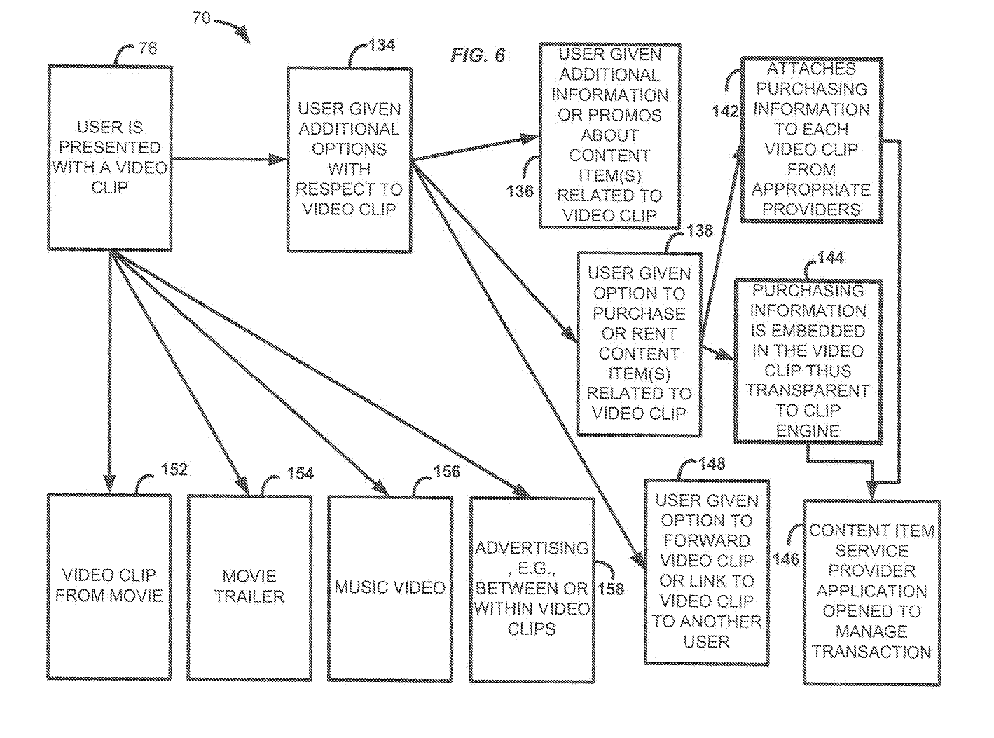

Referring to FIG. 5, a diagram 60 is shown illustrating different ways in which step 76, i.e., the user is presented with a video clip, may be accomplished. As mentioned above, a video clip may be streamed to the client device (step 114), a video clip may be downloaded to the device and played back substantially contemporaneously (step 116), e.g., in real time, or a video clip, previously downloaded, e.g., in a background process, may be caused to be played back (step 118). The causing to be played back may be via a signal sent from the clip engine, the clip database, the digital widget, or the like.

In another implementation, the video clip may be played back in a browser, with a suitable plug-in if necessary (step 122). In this case, a step of registering the plug-in may also be performed.

In yet another implementation, the video clip may be played within the context of a native device application (step 124). For example, the video clip may be played back in a media player window designed for this purpose. In this case, the video clip may be played embedded within the native device application (step 126). For example, the calendar application may have a window provided for playing video clips. Alternatively, the video clip may be played back overlaid on the native device application (step 128). In this way, a user may continue to see aspects of the underlying application while still enjoying the clip. In another implementation, the video clip may be played in an entirely separate and unrelated window (step 132). In this way, the video clip may be moved to another part of a desktop or otherwise manipulated for separate viewing. Other implementations will also be understood to be possible given this disclosure.

Referring to FIG. 6, a diagram 70 illustrates additional different ways in which step 76, i.e., the user being presented with a video clip, may be accomplished. First, as noted above, the clip may be represented by any number of different types of digital content items, including video clips from movies (step 152), movie trailers, (step 154), music videos, (step 156), advertising, e.g., between or within video clips (step 158), and so on. For example, other types of digital content may be included such as audio content, images, electronic books, other textual content including webpages, and so on.

The user may also be given additional options with respect to the video clip (step 134). For example, a user may be given additional information or promotional information or offers about content item(s) related to the video clip (step 136). That is, the user may be given information about release dates of digital or disc versions of the content item, access to downloadable or printable coupons for the content item or for merchandising related to the content item, or the like.

The user may also be given the option to forward the video clip, or a link thereto, to another user (step 148). Forwarding options may also be provided within the context of a social networking site or associated application.

The user may also be given the option to purchase or rent a content item or items related to the video clip (step 138). For example, if the video clip is a movie trailer, the associated content item may be the movie. Another associated content item may be a music video associated with the movie.

To accomplish the purchasing or renting, purchasing information must be accessible to the user. In one implementation, the purchasing information may be attached to each video clip as provided from appropriate providers (step 142). In this implementation, the purchasing information may be sent along with the video clip file or in a separate transmission. The appropriate providers are generally service providers that can sell or rent content. In another implementation, the purchasing information may be embedded in the video clip (step 144). In this way the purchasing information is transparent to the clip engine. In either case, access to the purchasing information allows the handling of a transaction (step 146) which in turn opens access to the associated content item, e.g., by allowing the downloading or streaming of the content item.

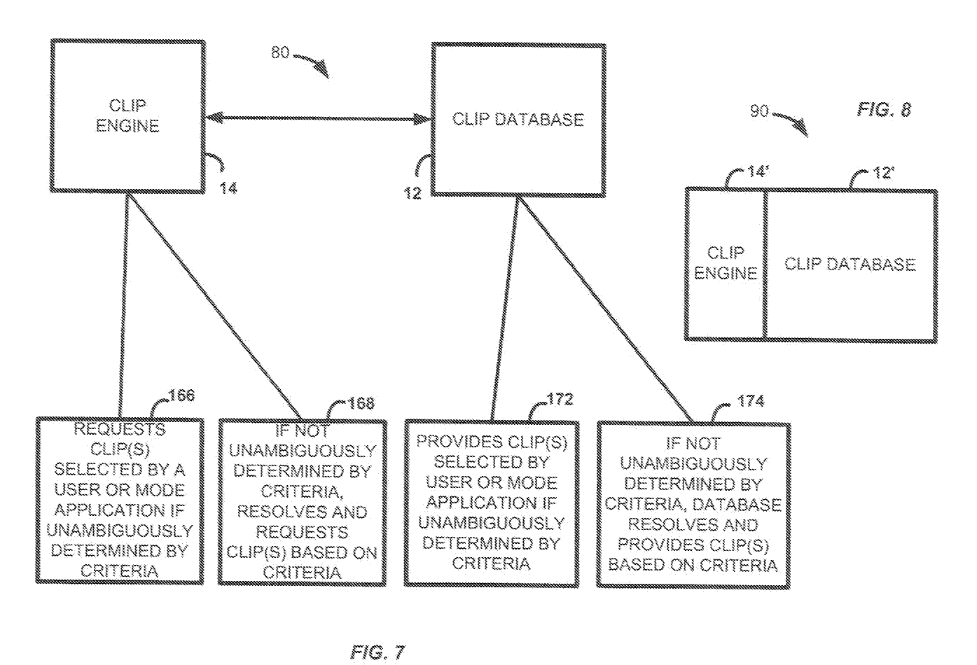

FIG. 7 illustrates one implementation of a clip engine and clip database system 80. The clip engine 14 is illustrated in signal communication with the clip database 12. In one alternative, the clip engine 14 uses data from the client device to request one or more clips selected by a user or mode application (or other application) if the clip or clips are unambiguously determined by the criteria (step 166). For example, if the user requests a specific clip or if the criteria set by the user are such that only one clip matches the same, the clip may be immediately retrieved from the clip database. Alternatively, if the criteria do not unambiguously determine a single clip, the clip engine may resolve and request a number of clips based on the criteria (step 168). In other words, the clip engine may perform a calculation (by comparing criteria with metadata) to determine and request clips that match the criteria. In either case, a portion of the calculation may be performed if necessary by the client device or by the clip database. In general, some level of calculation or resolving will be necessary, but if the clip is uniquely determined thereby, the same may be immediately played back. If not, the user may be presented with a number of clips, and the user interface may allow the selection of one or more clips according to the desire of the user.

Also as shown in FIG. 7, the clip database 12 may provide clips selected by the user or mode application (or other application) if unambiguously determined by the criteria (step 172). If not unambiguously determined by the criteria, the clip database 12 itself may also be the module which resolves which clip or clips meet the criteria, as well as the module that provides clips based on the criteria (step 174).

In the implementations illustrated in FIG. 7, either the clip engine or the clip database, or both, can perform some level of resolving, where the resolving relates to matching clip metadata with criteria. The criteria is generally provided from a client device, although in some cases information from the clip engine may also be employed, e.g., if the clip engine stores information about past views, and so on. In addition, in some implementations, the client device may provide some level of resolving or pre-resolving, or may alternatively convert criteria to a form better suited for the resolving.

Referring to FIG. 8, an alternative implementation 90 is illustrated in which a clip engine 14′ is provided as a front end component or module of the clip database 12′. In this implementation, the clip engine forms a part of the clip database, and their functions are accordingly integrated or shared.

FIG. 9 illustrates a system 100 including a client device 16 in communication with a clip engine 14 and clip database 12, where the client device is running one or more of mode applications 184, 186, 188, or 192. The mode applications may be provided with external information and/or control, such as within (or communicating with) a social networking site 194. The social networking site 194 may provide the external information and/or control either as an installed application within the social networking site or as an option run from within the social networking site framework. In such a system, users can access applications at the social networking site and the clip engine 14 can provide clips back to the social networking site, for display and sharing. A sharing facility 196 is also provided, either within the social networking site 194 or elsewhere, such that users can share mode application results or video clips. Users can view and share clips through the social networking site, posting clips to their own pages or their friends' pages, or retrieving clips from other people's pages. For example, a user could search for their favorite movie quotes and post the resulting clips to their page or send the same to a friend for posting on their friend's page.

In each mode, the types of available requests are different and determine how the clip engine 14 selects clips to return. Each mode may employ a different interface for the user, operating as a separate application. The user may interact with the mode application and the mode application may interact with the clip engine, sharing data as appropriate. The modes can operate together or with overlapping functionality, as well as operating entirely separately.

One mode application is similar to the “clip of the day” application described above in connection with FIG. 2. In particular, a daily mode application 192 may be employed in which a user receives a clip on a periodic basis. The user can enter various settings to direct the clip selection in a particular way. For example, the user may enter a setting such as favorite actors, and clips may be culled from such favorite actors. The user can also enter the various settings along with weightings for the various settings. Rules may be entered to cause, or not cause, particular clips to display at particular times. The selection of clips may also be based on a user profile and historical actions, e.g., purchases made by the user, click-thrus of the user, a viewing history of the user, a library or accumulated other purchases of a user if available, and the like. Such information may also be determined from a user's presence in a social networking site. In this regard, not only the interests of the user, but also that of their friends, and stated interests or groups, may determine clips. Any other such factor as has been described may also be employed, as well as others, including release dates of content items corresponding to clips, and the like. In this mode, random clips may also be enabled.

Another mode application is a quiz mode 188. In this mode, a user answers trivia questions employing a trivia quiz interface within the user interface 56 (or, e.g., within a social networking site). In this mode, the clip may be played before, during, or after a question. For example, the clip engine may provide clips to supplement questions in the quiz game. In one implementation, the clip may be provided as part of a question, e.g., “identify the movie for this clip (or actor)” or “which clip is from a particular movie?”, i.e., showing multiple clips. The clip may also be provided as an answer or part of an answer, e.g., when the answer to a question is a movie or a scene from a movie, the clip may be provided to illustrate the movie or scene. Additional aspects of such a quiz mode application are described below in reference to FIG. 10, particularly with regard to a social networking application thereof.

Another mode application is a search mode 186. In this mode, a user enters search criteria on a search interface. The criteria may include movie titles, dialogue, quotes, actors, crew, year of release, language, country, studio, genre, box office sales, release date, popularity, or the like. The results of the search mode may be a particular clip or group of clips corresponding to a particular movie, actor, quote, or any other such criterion as disclosed above or the like. The clip engine 14 may derive one or more criteria from the search entered by the user and may further create the query itself from the derived criteria.

Another mode application is a response form 184. The response form 184 may be employed to, e.g. create a “personality” mode, where the clip engine provides clips matching personality or mood traits. The traits may be derived from a user profile or from responses to questions on a form. The clip engine matches the traits to appropriate metadata associated with the clips. For this matching step, a lookup table may be employed to match the traits to moods or leitmotifs associated with a movie or to particular scenes therein, as noted by associated metadata. Such metadata may be assigned or may be derived based on characteristics of the movie or scenes. The clip engine may also provide a recommendation or suggestion of content items that may match the user's mood or personality, and may play clips corresponding to such content items. In addition the traits may be not for the requesting user but for another person. For example, if a friend is having a bad Monday, a user may share a clip appropriate to a bad Monday, e.g., a clip of a movie showing a character having a bad Monday.

In one particular implementation of the personality mode, the result may be embodied as a playlist of clips which becomes the viewer's personalized personality trailer. The trailer conveys the personality of the viewer through a series of relevant movie clips. One or more of the individual clips within the trailer may be introduced by a graphic with text which sets up the clip in a way that relates to the viewer's personality, e.g., “John is shy and sometimes awkward . . . ” and the trailer would cut to a clip of a movie with a character that is awkward and shy.

FIG. 10 is a flowchart 110 illustrating additional details of the quiz mode application 188. A first step is that the quiz mode application is instantiated (step 198). The same may be a stand-alone application, a web application, a social networking site application, or the like, so long as the same can communicate with the clip engine. A next step is that the quiz is displayed (step 202). A user takes the quiz (step 204), and may share the quiz while they are taking it (step 206). A clip may be provided for user viewing before, during, or after a quiz question (step 208). The user may be given an option to purchase a movie or other content item associated with the viewed clip (step 212).

After the quiz, a variety of options may be provided to the user. Exemplary ones are shown in FIG. 10. For example, a user may take another quiz (step 214). Alternatively, a user may retake the same quiz (step 216), in the hopes of obtaining a higher score. A user may share the quiz (step 218). In this way, a user may challenge another user or friend to beat their score. Finally, a user may share their results with other users or friends (step 222). In so doing, a user may post their quiz result to their wall and add comments (step 224). In this or other modes, the user can post an exemplary clip and can tag the clip for how it can be shared or reposted, e.g., not at all, one time, freely, or the like. In certain social networking sites, a user may be given the option of indicating approval of a posted clip, quiz, or result, such as by clicking a “LIKE” button (step 226). Finally, but not exclusively, a user may share their result by a share internal to the social networking or other site, by an external share, or by simply copying a link to the clip and sending the link via e-mail to their friends (step 228).

In this way, a user can take quizzes and challenges using the social networking site based on their favorite movies. The quizzes may incorporate clips in the questions and answers provided by the clip engine. Quizzes may be provided whereby the responses indicate likeness of a user to a character within a movie, or to a movie itself. In this way, a user may be entertained to find out what movie or character or scene matches their personality, mood, relationship, or virtually any aspect of a movie for which metadata can be provided and in which users can provide data.

FIG. 11 illustrates an alternative implementation according to the principles described here, in which users are enabled to create their own clips, this implementation termed “clip and share”. This implementation can be an application within a social networking site or other third-party site, or may also be a stand-alone application. In general, the application has access to the clip engine 14.

In the flowchart 120 of FIG. 11, a first step is that the clip and share application is instantiated (step 232). One or more content items may be selected (step 234) by a user search, a suggestion on the basis of a user profile, or by any other technique by which a user may identify a desired content item. Premade clips corresponding to content items may be provided and, if so, a user may select a premade clip (step 236). In this step, at least one and generally more clips are provided of famous or noteworthy scenes within the content item, and a user selects one or more of these clips. A user may also create a custom sub clip (step 242) by selection of an in-point and an out-point, which delineate when a clip starts and stops, respectively. The in-point and out-point may be selected from a premade clip or from the content item itself. A user may then combine the clips selected in step 236 with the clips created in step 242 in any desired order, to create a custom clip (step 238), which may be considered a playlist of clips.

Limitations may be placed on the creation of such custom clips. Such limitations provide a control on how much of a content item may be appropriated using clips. Such limitations may include a time limit on length of custom sub clips and custom clips. For example, if the overall length of a custom clip cannot exceed four minutes, then the distance in time between an in-point and an out-point may not exceed four minutes. Other limitations and rules may be implemented. These limitations may be implemented by business rules, and the business rules can exist in the metadata or in the application itself. For the latter, the application may simply be hardcoded such that the playlist cannot exceed a predetermined limit, e.g., four minutes.

Where the clips are not video clips, analogous rules may apply. For example, where clips pertain to an electronic book, the limitation may be on a number of pages or characters. It will be understood that the rules may be arbitrary, according to the needs and desires of the content owner.

Once the custom clip is created, the user may add embellishments (step 244), e.g., a score, other music, titles, credits, keywords for searching, tags, or the like. In this way, clips may be searchable by keyword, creator, and so on. A user may then preview the result (step 246). A user may then save and share their result (step 248). The user may correspondingly provide and accept comments on the shared custom clip, may accept approval clicks such as “likes”, may set the custom clip as a favorite, file the custom clip in a folder, and so on.

The user, as well as other viewers, may be offered promotions for content items included in the resulting custom clip (step 252). In other words, for any content items having clips appearing in the custom clip posted by the user, promotions, advertising, or marketing pertaining to such items may be offered to the creator or viewers of the custom clip. Where a conversion occurs, i.e., a user or friend purchases or rents a content item associated with the custom clip, a backend transaction (step 254) may be performed to accommodate digital rights issues, including compensation to the content owner or owners.

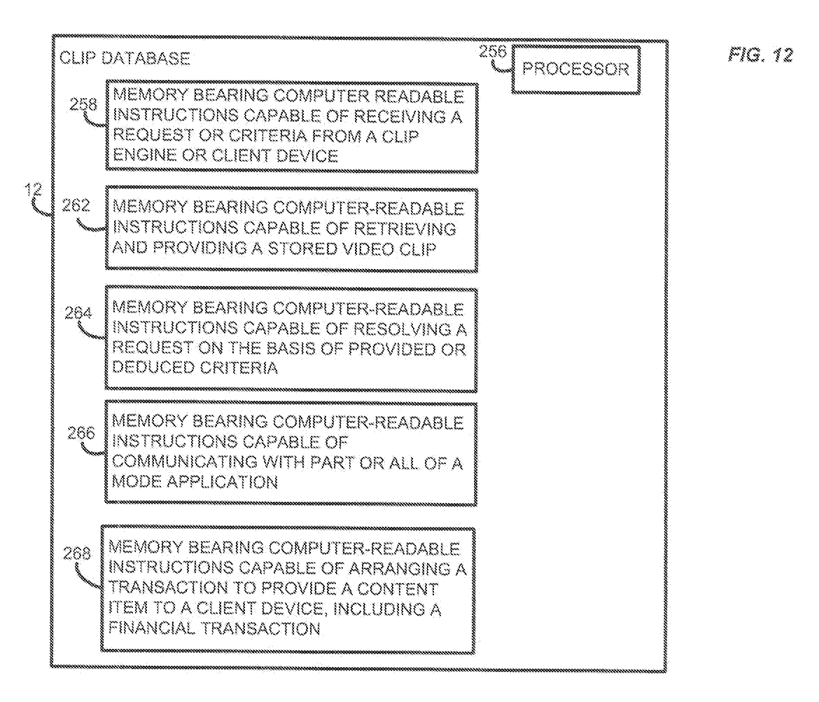

FIG. 12 illustrates one exemplary implementation of a clip database 12, the same including a processor 256. The clip database 12 may include memory 258 bearing computer readable instructions capable of receiving a request or criteria from a clip engine or client device. For example, the memory 258 may receive the criteria in a form suitable for direct selection of a clip or clips or may receive the request for future conversion into suitable criteria by another component. The clip database 12 also includes memory 262 bearing computer readable instructions capable of retrieving and providing a stored video clip. The memory 262 is capable of retrieving the stored clip, or creating a clip having been provided an in-point and out-point as described above. Alternatively, the memory 262 may retrieve the clip (or create the clip) from another source, such as a separate content provider. The clip database 12 also includes memory 264 bearing computer readable instructions capable of resolving a request on the basis of provided or deduced criteria. The memory 264 may be employed to accept a request in the form of a search query or trivia questions or the like and converts the same into criteria which may be matched against metadata or other data associated with content items or video clips. The memory 264 is not necessary in all implementations, as this functionality may also be incorporated within the clip engine 14 and to a certain extent into a client device 16. The clip database 12 may further include memory 266 bearing computer readable instructions capable of communicating with part or all of a mode application. In other words, the memory 266 may be employed to communicate with a mode application which may in turn be a desktop widget such as a calendar application, a social networking site application, or other types of applications as have been discussed. The mode application is generally hosted by a clip engine, but the same may also be hosted or form part of a client device or clip database. The clip database 12 further includes memory 268 bearing computer readable instructions capable of arranging a transaction to provide a content item to a client device, including a financial transaction. The memory 268 may work in conjunction with various content or service providers and may be invoked when the purchasing information with or within a provided video clip is leveraged to purchase or rent content. Some of the functionality of the memory 268 may also be incorporated within the clip engine 14.

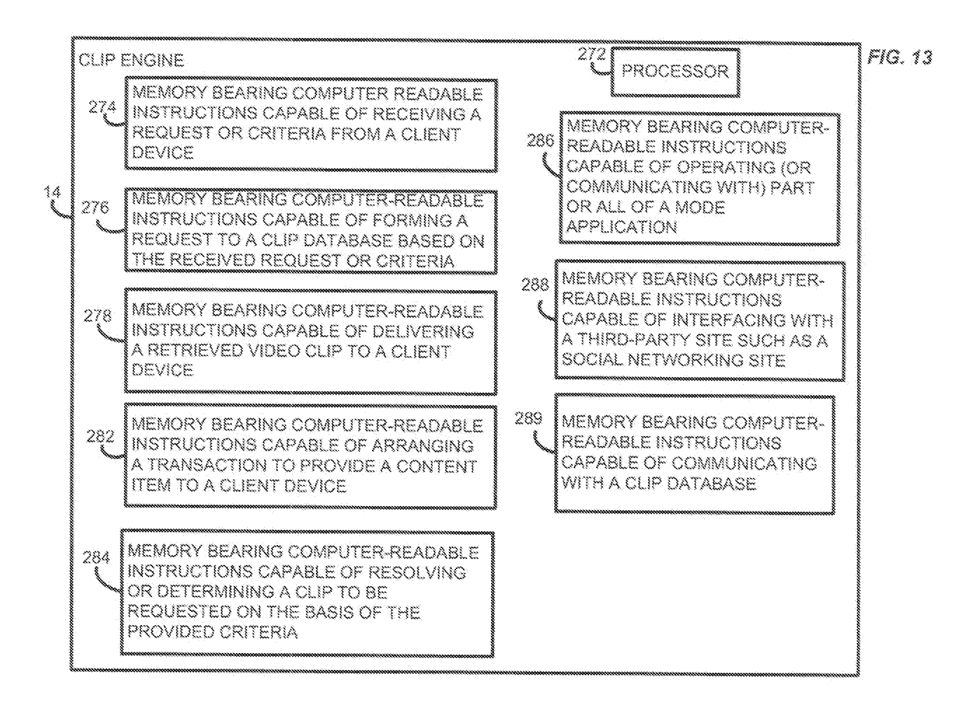

FIG. 13 illustrates one exemplary implementation of a clip engine 14, the same including a processor 272. The clip engine 14 includes a memory 274 bearing computer readable instructions capable of receiving a request or criteria from a client device. The memory 274 may be similar to the memory 258, and in particular includes instructions allowing the clip engine to receive data from the user interface 56 of the client device 16, e.g., search requests, settings for desktop widgets, quiz answers, form responses, and the like. The clip engine 14 further includes memory 276 bearing computer readable instructions capable of forming a request to a clip database based on the received request or criteria. The memory 276 may be employed to form the request or query to the clip database 12 in a form that is suitable for the clip database. The clip engine 14 further includes memory 278 bearing computer readable instructions capable of delivering a retrieved video clip to a client device. The delivery may be in a number of ways, including streaming, downloading, or the like. It is noted in this regard that delivery may also be provided directly from the clip database 12 to the client device 16. The clip engine 14 further includes memory 282 bearing computer readable instructions capable of arranging a transaction to provide the content item to a client device. This memory 282 is the counterpart of the memory 268 in the clip database, and the two may work together to arrange a transaction whereby the client device 16 obtains access to a desired content item, either by purchase, rental, or the like. The functionality of the transaction arrangement may be shared by the memories, or one of the memories may be entirely responsible for the transaction.

The clip engine 14 further includes memory 284 bearing computer readable instructions capable of resolving or determining a clip to be requested on the basis of provided criteria. That is, when the form provided to the clip engine is sub optimal or simply not appropriate for direct application against clip metadata within clip database 12, the memory 284 may be employed to resolve or otherwise determine a clip or group of clips appropriate for response to the request or criteria.

The clip engine 14 further includes a memory 286 bearing computer readable instructions capable of operating or communicating with part or all of a mode application. The memory 286 may be employed to either operate the mode application itself, or communicate with another platform for the operation of the mode application. For example, if the mode application is a daily provision of video clips, the memory 286 may incorporate much of the functionality needed to run the application. However, if the mode application is a response form application run in part on a separate server, e.g., in “personality” mode, then the memory 286 may be employed to communicate data to and from the separate server to accomplish the goals of the application. The clip engine 14 further includes memory 288 bearing computer readable instructions capable of interfacing with a third-party site such as a social networking site. In this way, the clip engine can communicate data, e.g., clips and responses, respectively, to and from the social networking site to accomplish the goals of social networking applications such as quizzes, surveys, response forms, and the like.

The clip engine 14 further includes a memory 289 bearing computer readable instructions capable of communicating with the clip database 12. In this way, the clip engine 14 can communicate requests and criteria to the clip database 12 and receive clips in response, or notifications that clips have been directly delivered to a client device 16.

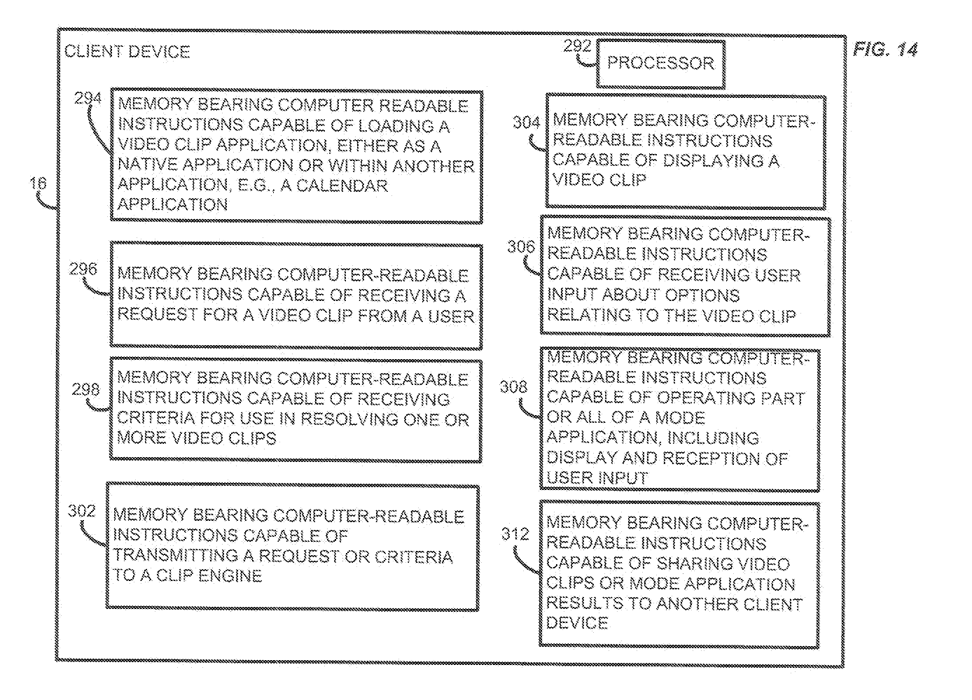

FIG. 14 illustrates an exemplary client device 16, including a processor 292. The client device 16 includes memory 294 bearing computer readable instructions capable of loading a video clip application, either as a native application or within another application, e.g., a calendar application. Variations will also be seen. For example, the video clip application may be a web application, and video clips may play in a plug-in. The client device 16 further includes memory 296 bearing computer readable instructions capable of receiving a request for a video clip from a user. The request may be in a number of forms, as has been described, including settings for calendar applications or desktop widgets, responses to forms, responses to trivia questions, or the like. The client device 16 further includes memory 298 bearing computer readable instructions capable of receiving criteria for use in resolving one or more video clips. This memory 298 may overlap with the memory 296 in some ways. The memory 298 is particularly useful in receiving criteria rather than direct requests. For example, the memory 298 may receive criteria such as actor information, genre information, and other information useful in determining one or more clips be delivered. It is noted that depending on the capabilities of the client device 16, the client device 16 may provide some level of resolution of clips given received requests and/or criteria. The client device 16 further includes a memory 302 bearing computer readable instructions capable of transmitting a request or criteria to a clip engine. The memory 302 may communicate by any number of techniques, including wireless techniques, wired techniques, and the memory 302 generally incorporates known methods of network transmission. The client device 16 further includes a memory 304 bearing computer readable instructions capable of displaying a video clip. For example, the video clips may play in a separate window intended for this purpose, in a browser plug-in, in a display window particular to the native application, e.g., calendar application, or the like. The client device 16 further includes a memory 306 bearing computer readable instructions capable of receiving user input about options relating to the video clip. For example, the memory 306 may allow the reception of user input requesting additional information, requesting coupons to be downloaded corresponding to related content items, or the like. The client device 16 further includes a memory 308 bearing computer readable instructions capable of operating part or all of the mode application, including the display and reception of user input. The memory 308 may be employed to operate generally the client side of such applications, including input of settings, input of responses or answers to questions, as well as display of questions, forms, and video clips, as well as associated content items. Generally, the server side of such applications is handled by the clip engine 14 or clip database 12. In various implementations, the client side of such applications can be thin or substantial.

The client device 16 further includes memory 312 bearing computer readable instructions capable of sharing video clips or mode application results to another client device. The memory 312 may be employed to communicate directly to another client device using known messaging techniques or may operate through an intermediary such as a file sharing server or social networking site. The memory 312 may also be employed to post video clips or mode application results to servers or sites for subsequent access by other client devices. The memory 312 may further be employed to control access to such posts.

Other memories will also be understood, although these are not shown in FIGS. 12-14. For example, memories may be provided which bear computer-readable instructions capable of creating quizzes and response forms, establishing authentication, and the like.

In an alternative implementation, these memories may be implemented as modules, either in software, hardware, or various forms of firmware. For example, a communications module may be employed to communicate data between the clip engine and the client device, as well as between the clip engine and the clip database. A database module may be employed to handle database functionality for the clip database. Other modules will also be understood.

Systems and methods have been disclosed that provide for systematic access of clips, e.g. daily access or other such provision of video clips. As disclosed above, users may be provided with a convenient and enjoyable way to see video clips, as well as a convenient way to access, e.g., purchase or rent, content items related to the clips.

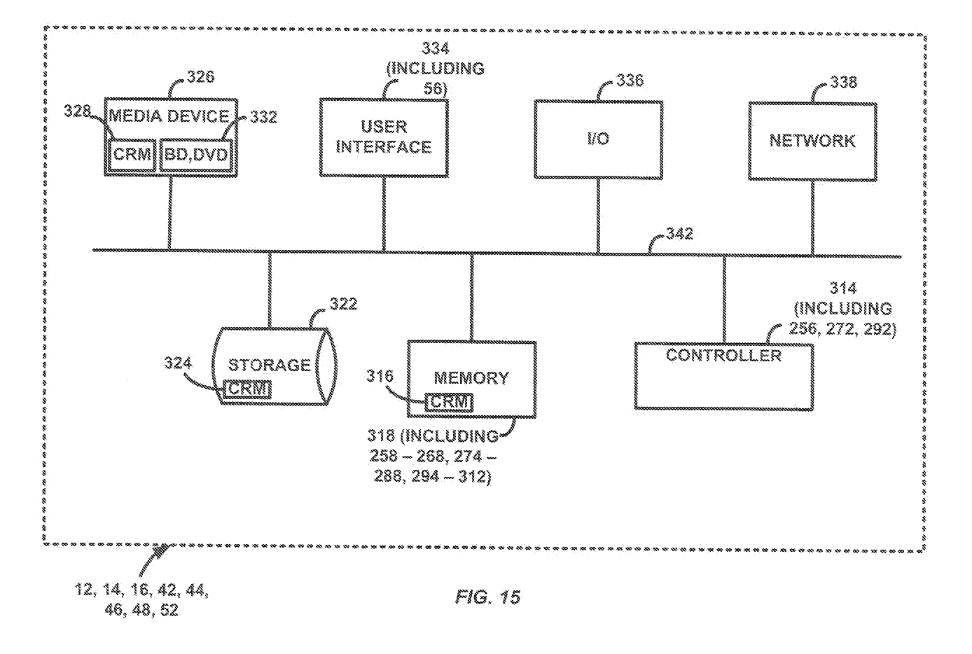

One implementation includes one or more programmable processors and corresponding computing system components to store and execute computer instructions, such as to execute the code that provides the client device, clip engine, or clip database. Referring to FIG. 15, a representation of an exemplary computing environment for a client device, clip engine, or clip database is illustrated.

The computing environment includes a controller 314, a memory 318, storage 322, a media device 326, a user interface 334, an input/output (I/O) interface 336, and a network interface 338. The components are interconnected by a common bus 342. Alternatively, different connection configurations can be used, such as a star pattern with the controller at the center.

The controller 314 includes a programmable processor and controls the operation of the devices and servers and their components. The controller 314 loads instructions from the memory 318 or an embedded controller memory (not shown) and executes these instructions to control the system. In its execution, the controller 156 may provide the clip engine 14 as, in part, a software system. Alternatively, this service can be implemented as separate modular components in the controller 314.

Memory 318, which may include non-transitory computer-readable memory 316, stores data temporarily for use by the other components of the second display and servers, and the same may include memories 258-268, 274-288, and 294-312, as discussed above. In one implementation, memory 318 is implemented as RAM. In other implementations, memory 318 also includes long-term or permanent memory, such as flash memory and/or ROM.

Storage 322, which may include non-transitory computer-readable memory 324, stores data temporarily or long-term for use by other components of the devices and servers, such as for storing data used by the system. In one implementation, storage 322 is a hard disc drive or a solid state drive.

The media device 326, which may include non-transitory computer-readable memory 328, receives removable media and reads and/or writes data to the removable media. In one implementation, the media device 326 is an optical disc drive or disc burner, e.g., a writable Blu-ray® disc drive 332.

The user interface 334 includes components for accepting user input from the user of, e.g., the client device, and presenting information to the user. In one implementation, the user interface 334 includes a keyboard, a mouse, audio speakers, and a display. The controller 314 uses input from the user to adjust the operation of the, e.g., client device 16.

The I/O interface 336 includes one or more I/O ports to connect to corresponding I/O devices, such as external storage or supplemental devices, e.g., a printer or a PDA. In one implementation, the ports of the I/O interface 336 include ports such as: USB ports, PCMCIA ports, serial ports, and/or parallel ports. In another implementation, the I/O interface 336 includes a wireless interface for wireless communication with external devices. These I/O interfaces may be employed to connect to one or more content service providers.

The network interface 338 allows connections with the local and wider networks and includes a wired and/or wireless network connection, such as an RJ-45 or Ethernet connection or “WiFi” interface (802.11). Numerous other types of network connections will be understood to be possible, including WiMax, 3G or 4G, 802.15 protocols, 802.16 protocols, satellite, Bluetooth®, infrared, or the like.

The client device, clip engine, and clip database may include additional hardware and software typical of such devices, e.g., power and operating systems, though these components are not specifically shown in the figure for simplicity. In other implementations, different configurations of the devices can be used, e.g., different bus or storage configurations or a multi-processor configuration.

Various illustrative implementations of the present invention have been described. However, one of ordinary skill in the art will recognize that additional implementations are also possible and within the scope of the present invention. For example, various types of content items can be delivered, such as television or Internet video, audio, text, or web content. Accordingly, the technology is not limited to retrieving and playing back movie clips. Variations will be seen in the type of mode applications that can be created given the platform of the technology. For example, a user may answer a series of questions, e.g., based on mood or experiences, and the system may choose a movie most indicative of their responses. Such may be assumed to be a movie the user may desire to watch. A video clip of the movie may be provided. On the other hand, if the user is feeling down, the system may suggest a comedy or upbeat movie. Such question and answer formats may also be appropriate for other applications. For example, before or after watching a video clip, or its associated content item, a user may answer a series of questions intended to determine which character in the movie the user is most like. Following the series of questions, the user may be shown a video clip with the character prominently featured. In the same way, a user may answer such a set of questions for another user. In addition, movie clips may be combined together that represent a progression of moods or experiences in a user's life or a time period thereof. For example, a user may answer a series of questions that elicit a series of feelings or emotions or categories of experience, or the like. The clip engine may string together a series of clips evoking those feelings and experiences. Essentially the same creates a movie trailer evocative of the user's life. In another application, a user may enter particular criteria, such as a line of dialogue, and a number of scenes may be presented incorporating that or similar dialogue. The user may then choose the scene to view or share based on which most accurately conveys the point the user was trying to make by sharing the scene. Prompts may be provided to help users search, e.g., prompts for fields for title, actor, dialogue, director, or the like. The quiz mode may incorporate multiplayer interactions. In quizzes and trivia applications, points may be accumulated by a user which may be redeemed for coupons, additional insights or data about associated content items, e.g., gag reels or the like, or other items of value to a user. For example, if a user answers questions correctly about a movie, an associated music video may be provided to or accessed by the user. It should be noted that in quiz applications, there may be no particular right or wrong answer, but different answers or sets of answers may lead to selections of different clips. Where a social networking site may be incorporated as a basis for input or output, the determined or resolved clip(s) may be posted to a user's wall, a friend's wall, or anyone's wall to which the user has posting access. In another variation, for, e.g., the calendar mode application, business rules may be supported. Such business rules may include for how many days in the past or future to allow users to see clips or notifications of clips. For example, all clips from the past may be available, up to a predetermined point. For future days, clips may not yet be available, but a reminder may be set for the viewer to be prompted to view the clip when that future day becomes the present day.

Accordingly, the present invention is not limited to only those implementations described above.

1. A method of providing clips from a clip database to a client device using a clip engine, comprising:
a. receiving a request for a clip from a client device;
b. retrieving a clip responsive to the request from the clip database; and
c. delivering the clip to the client device.

2. The method of claim 1, wherein the receiving a request for a clip from a client device includes receiving notification that a user has opened an application.

3. The method of claim 2, wherein the application is a calendar application or a desktop widget or a social networking site application.

4. The method of claim 1, wherein the clip engine is integrated into the clip database.

5. The method of claim 1, wherein the delivering includes streaming or downloading.

6. The method of claim 1, wherein the clip includes embedded data about purchasing a content item related to the clip.

7. The method of claim 1, further comprising downloading data about purchasing a content item related to the clip.

8. The method of claim 1, further comprising causing an offer to be displayed at the client device, the offer for a content item or for information, promotional materials, or goods or services related to the content item, the content item corresponding to the clip.

9. The method of claim 1, wherein the receiving a request for a clip from a client device includes receiving criteria indicative of one or more clips.

10. The method of claim 9, wherein the criteria are from a user form.

11. The method of claim 10, wherein the user form requests information about user preferences, desires, indications, or moods.

12. The method of claim 9, wherein the criteria are from a quiz.

13. The method of claim 12, wherein a quiz question includes a clip.

14. The method of claim 12, wherein a quiz answer includes a clip.

15. The method of claim 1, wherein the clip delivered to the client device is a custom clip prepared by a user, using a method comprising:
a. in a video file of a content item or in a premade sub clip, selecting an in-point and an out-point, and defining a custom sub clip between the in-point and the out-point;
b. selecting a premade sub clip from a collection of premade sub clips; and
c. stringing at least one defined custom sub clip and one selected premade sub clip in a desired order to create a custom clip.

16. The method of claim 15, further comprising adding titles, credits, music, scores, soundtrack, or sound or video effects to the custom clip.

17. The method of claim 15, further comprising sharing the custom clip by publishing the custom clip to a social networking site.

18. The method of claim 1, wherein the retrieving a clip includes delivering information about a content item and an in-point and an out-point of the content item to a clip database.

19. A non-transitory computer readable medium, comprising instructions for causing a computing device to implement the method of claim 1.

20. A clip engine for providing clips from a clip database to a client device, comprising:
a. a communications module for a client device, the client communications module receiving client requests for clips from the client device and delivering retrieved clips to the client device; and
b. a communications module for a clip database, the database communications module transmitting clip engine requests for clips from the clip engine to the clip database, and receiving clips from the clip database for subsequent transmission to a client device.

21. The clip engine of claim 20, wherein the clip engine forms a front end of a clip database.

22. The clip engine of claim 20, wherein at least one of the client requests or the clip engine requests are presented to the clip engine or the clip database, respectively, in the form of criteria, and wherein the clip engine or the clip database, respectively, resolve which clips to deliver on the basis of the criteria.

23. The clip engine of claim 20, wherein the criteria are from a user form.

24. The clip engine of claim 20, wherein the criteria are from a quiz.

25. The clip engine of claim 20, wherein the criteria are from at least one of user preferences, user settings, user data, or user ratings.

26. The clip engine of claim 20, wherein the database communications module transmits clip engine requests for clips by delivering information about a content item and an in-point and an out-point of the content item to the clip database.

27. A method for requesting and receiving clips from a clip database using a clip engine, comprising:
a. generating a request for a clip in an application;
b. transmitting the generated request to a clip engine;
c. receiving a clip responsive to the request from a clip database or from the clip engine; and
d. playing back the clip.

28. The method of claim 27, wherein the playing back occurs in the application.

29. The method of claim 27, wherein the playing back occurs overlaid on a user interface of a client device.

30. The method of claim 27, wherein the playing back occurs in a plug-in.

31. The method of claim 27, further comprising displaying an offer, the offer for a content item or for information, promotional materials, or goods or services related to the content item, the content item corresponding to the clip.

32. A non-transitory computer readable medium, comprising instructions for causing a computing device to implement the method of claim 27.

33. The medium of claim 32, wherein the instructions are downloaded as an application program to a client device.

34. A method of providing clips from a clip database to a client device using a clip engine, comprising:
a. downloading a clip to a client device
b. receiving a request for a clip from a client device;
c. upon the receiving, causing a playback of the downloaded clip on the client device.

35. The method of claim 34, wherein the downloading is performed as a background process, based on a user profile.

36. The method of claim 35, wherein the user profile includes information about at least one of user transaction or purchase history, user data from a social networking site, or user preferences.

37. A non-transitory computer readable medium, comprising instructions for causing a computing device to implement the method of claim 34.

38. A clip engine for providing clips from a clip database to a client device, comprising:
a. a communications module for a client device, the client communications module receiving client requests for clips from the client device and delivering retrieved clips to the client device; and
b. a communications module for a clip database, the database communications module transmitting clip engine requests for clips from the clip engine to the clip database, and arranging for transmission of clips from the clip database to a client device.
